(19) United States
(12) Patent Application Publication
(10) Pub. No.: US 2011/0050598 A1
(43) Pub. Date: Mar. 3, 2011

(54) TOUCH SCREEN DEVICE

(76) Inventors: Dong Sun PARK, Seoul (KR); Yeon Ho Son, Gyunggi-do (KR); Jae Kyung Kim, Gyunggi-do (KR)

(21) Appl. No.: 12/582,283

(22) Filed: Oct. 20, 2009

(30) Foreign Application Priority Data
Aug. 28, 2009 (KR) 10-2009-0080611

(51) Int. Cl. G06F 3/041

(52) U.S. Cl. 345/173

(57) ABSTRACT

Disclosed herein is a touch screen device. The touch screen device includes an upper casing, a touch screen panel, a first elastic member, an image display, a vibration unit, a second elastic member and a support bracket. The touch screen panel receives a touch signal from a user. The first elastic member is provided under the touch screen panel. The image display is mounted under the touch screen panel to display images. The vibration unit is mounted under the image display to generate vibrations. The second elastic member is provided under the image display to prevent the vibration of the vibration unit from being transmitted downwards. The support bracket is provided under the second elastic member to support the second elastic member.

### CROSS REFERENCE TO RELATED APPLICATION

This application claims the benefit of Korean Patent Application No. 10-2009-0080611, filed Aug. 28, 2009, entitled “Touch screen device”, which is hereby incorporated by reference in its entirety into this application.

### BACKGROUND OF THE INVENTION

1. Technical Field

The present invention relates to a touch screen device.

2. Description of the Related Art

Recently, according to requirements of consumers to enhance the convenience of using electronic products, there are an increasing number of electronic products using touch screens which allow a signal to be input in a manner wherein the presence and location of touching within a display area is detected. Touch screen devices not only include the concept of inputting a signal by touching but also include the concept of incorporating the intuitive experience of a user into an interface and of diversifying feedback.

Touch screen devices have many advantages because the size of a device can be reduced, it can be easily and simply manipulated, the specifications thereof can be easily changed, a user can easily recognize information, and it is compatible with other IT devices. Because of these advantages, touch screen devices are widely used in various fields including industry, traffic, services, medical care, mobile products, etc.

Typically, in touch screen devices, a transparent touch panel is disposed close to an image display, such as an LCD, which displays an image. A user observes the image through the touch panel and presses a desired portion of the touch panel, at which time a vibration unit applies vibration to the touch panel, thus transmitting a sensation of vibration to the user.

In a representative touch screen device according to a conventional technique, an upper piece of double-sided adhesive tape is attached to a lower surface of a touch screen panel. An upper casing is attached to the lower surface of the upper double-sided adhesive tape. An image display is mounted to the lower surface of the upper casing. A lower piece of double-sided adhesive tape is attached to the lower surface of the image display. A bracket supports the image display.

As such, in the conventional touch screen device, the touch screen panel is fastened to the upper casing by the upper double-sided adhesive tape, and the image display is fastened to the bracket by the lower double-sided adhesive tape.

However, because the elements are attached to each other using the double-sided adhesive tape, vibrations generated from the vibration unit are applied not only to the touch screen panel and the image display but also to the casing and the bracket which need not have vibrations applied thereto. Therefore, the intensity of the vibrations applied to the user through the touch screen panel is reduced. Furthermore, the conventional structure of coupling the elements to each other using the double-sided adhesive tape is disadvantageous in that the efficiency of transmitting vibration is unsatisfactory.

Accordingly, a structure capable of increasing efficiency of transmitting vibration from the vibration unit to the user is required such that the user can feel a satisfactory vibrational effect.

### SUMMARY OF THE INVENTION

The present invention has been made in an effort to provide a touch screen device which is constructed such that the efficiency of transmitting vibrations from a vibration unit to a touch screen panel can be maximized.

In a touch screen device according to an embodiment of the present invention, an upper casing is provided. A touch screen panel receives a touch signal from a user. A first elastic member is provided under the touch screen panel. An image display is provided under the touch screen panel to display images. A vibration unit is mounted under the image display to generate vibrations. A second elastic member is provided under the image display to prevent the vibrations of the vibration unit from being transmitted downwards. A support bracket is provided under the second elastic member to support the second elastic member.

The first elastic member may have a shape corresponding to a perimeter of the upper casing.

Furthermore, vibrational force applied to the touch screen panel may vary depending on a hardness of the first elastic member.

In addition, an adhesive material may be applied to each of upper and lower surfaces of the first elastic member, so that the touch screen panel is fastened to the upper casing by the first elastic member.

The vibration unit may comprise a piezoelectric or polymer actuator or motor.

As well, a displacement of the touch screen panel may vary depending on a frequency of the vibration unit.

Moreover, an adhesive material may be applied to each of upper and lower surfaces of the second elastic member, so that the image display is fastened to the support bracket by the second elastic member.

In the touch screen device according to the present invention, a first elastic member is disposed between a touch screen panel and an upper casing, and a second elastic member is disposed between an image display and a support bracket. Thus, the rate at which vibrations generated from a vibration unit are transmitted to the touch screen panel can be maximized, while vibrations transmitted from the vibration unit to the lower elements are minimized.

As well, force of the vibrations transmitted to the user when touching the touch screen panel can be varied by changing the hardness of the first elastic member. Hence, the present invention can meet the requirements of consumers who want various sensations of vibration.

As such, the touch screen device of the present invention may be able to maximize a sensation of vibration applied to the user when touching the touch screen panel. The touch screen device of the present invention may be able to provide various sensations of vibration to the user. Therefore, the marketability can be markedly enhanced.

### BRIEF DESCRIPTION OF THE DRAWINGS

The above and other objects, features and advantages of the present invention will be more clearly understood from the following detailed description taken in conjunction with the accompanying drawings, in which:

FIG. 1 is an exploded perspective view illustrating a touch screen device, according to an embodiment of the present invention;

FIG. 2 is an exploded perspective view of a part of the touch screen device according to the embodiment of the present invention;

FIG. 3 is an exploded perspective view of a part of the touch screen device according to the embodiment of the present invention;

FIG. 4 is a first graph showing the characteristics of the touch screen device according to the embodiment of the present invention; and

FIG. 5 is a second graph showing the characteristics of the touch screen device according to the embodiment of the present invention.

### DESCRIPTION OF THE PREFERRED EMBODIMENTS

Reference now should be made to the drawings, in which the same reference numerals are used throughout the different drawings to designate the same or similar components. In the following description, when it is determined that the detailed description of the conventional function and conventional structure would confuse the gist of the present invention, such a description may be omitted. Furthermore, the terms and words used in the specification and claims are not necessarily limited to typical or dictionary meanings, but must be understood to indicate concepts selected by the inventor as the best method of illustrating the present invention, and must be interpreted as having meanings and concepts adapted to the scope and sprit of the present invention for understanding the technology of the present invention.

Hereinafter, an embodiment of the present invention will be described in detail with reference to the attached drawings.

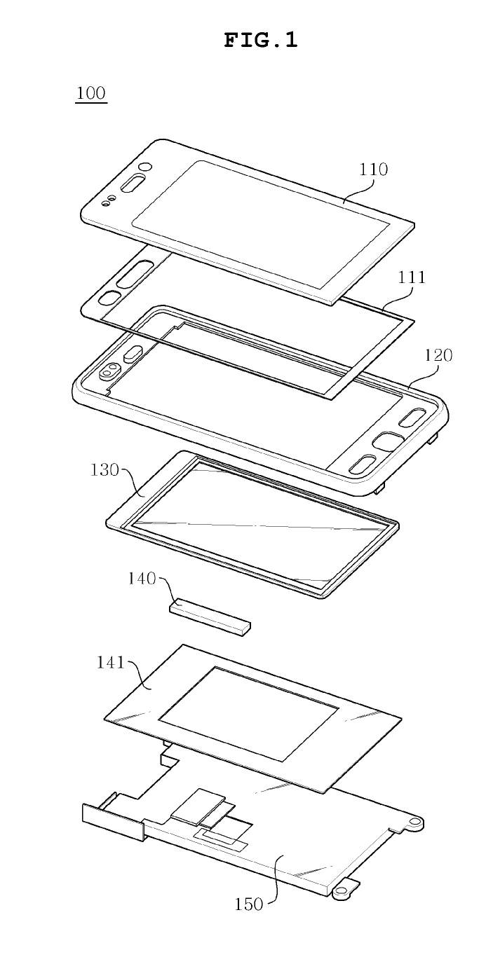

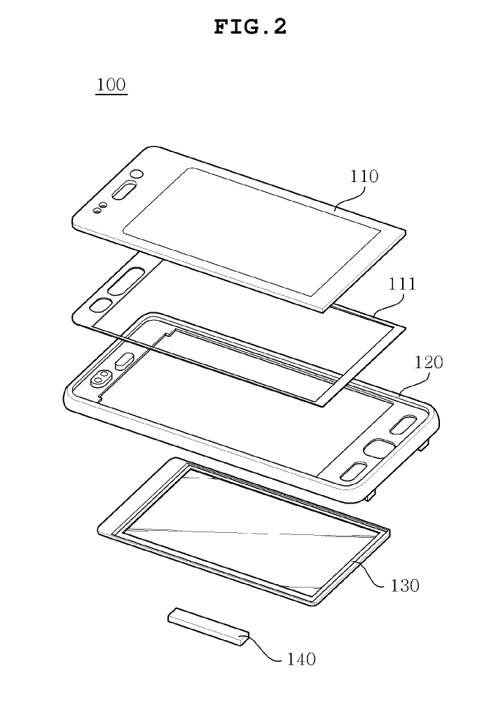

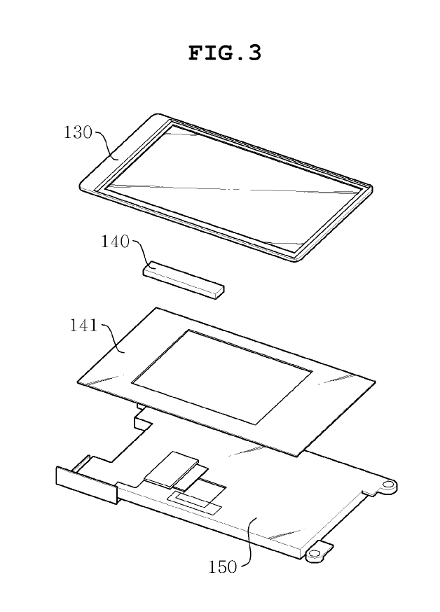

FIGS. 1 through 3 illustrate a touch screen device 100 according to the embodiment of the present invention. The touch screen device 100 includes a touch screen panel 110, an upper casing 120, an image display 130, a vibration unit 140 and a support bracket 150.

The touch screen panel 110 is transparent and flexible and functions as a signal input surface which enables a user to observe an image displayed on the image display 120 and press it to input a signal. For instance, the touch screen panel 110 has a rectangular shape which extends a predetermined length in the longitudinal direction of the touch screen device 100.

Furthermore, the touch screen panel 110 is made, for example, by laminating an outer film, an ITO (indium tin oxide) film and a base film.

In detail, the outer film is disposed on a front surface of a mobile communication terminal and is sectioned into a viewing area within which touch input is available, and a dead space area which is formed around the viewing area. The outer film is made of transparent film material, such as PET (poly ethylene terephthalate), to allow the user to observe the image display 130 through the outer film.

The ITO film is formed by laminating two upper and lower film layers, although it is not in detail shown in the drawings. A dot spacer is interposed between the upper and lower film layers of the ITO film to maintain the distance therebetween constant. An electrode membrane having an X-axis pattern and a Y-axis pattern is provided on the perimeter of each film layer. The X-axis pattern and the Y-axis pattern are electrically separated from each other by an insulator (not shown). The electrode membrane is exposed outside the ITO film through an FPC (flexible printed circuit) cable and is electrically connected to the mobile communication terminal.

The base film supports the entire touch panel. For example, a glass substrate having superior transmissivity and a high touch response speed can be used as the base film.

The upper casing 120 surrounds the edges of the touch screen panel 110 to protect the touch screen panel 110 from external impact.

Furthermore, a first elastic member 111 is interposed between the touch screen panel 110 and the upper casing 120. The first elastic member 111 couples the touch screen panel 110 to the upper casing 120 and performs a function of applying vibrations.

The first elastic member 111 may be made of rubber material, such as silicone rubber, D to provide a feeling of pushing the touch screen panel 110 when the user touches the touch screen panel 110, or alternatively, it may be made of foam.

The first elastic member 111 not only facilitates applications of vibrations generated from the vibration unit 140 to the touch screen panel 110 but also has the function of shock absorption, thus providing a good sensation of touch to the user.

Adhesive material is applied to the upper and lower surfaces of the first elastic member 111 to fasten the touch screen panel 110 to the upper casing 120. In addition, the first elastic member 111 controls the feedback of the vibration unit 140 using the characteristics of the elastic material.

Here, the first elastic member 111 has a shape corresponding to the perimeter of the upper casing 120, because it is provided along the perimeter of the upper casing 120. Moreover, the first elastic member 111 prevents vibrations generated from the vibration unit 140 from being applied to the upper casing 120.

As such, the first elastic member 111 is made of elastic material, such as silicone rubber, such that vibrations generated from the vibration unit 140 can be easily applied to the touch screen panel 110. Furthermore, because of adhesive material applied to the upper and lower surfaces of the first elastic member 111, the touch screen panel 110 can be easily fastened to the upper casing 120 by the first elastic member 111.

The image display 130 is mounted to the lower surface of the upper casing 120. The image display 130 converts a variety of electrical information provided by various units into visual information using the variation of transmittance of a liquid crystal which depends on applied voltage. The image display 130 comprises one or more layers.

The vibration unit 140 is mounted to the lower surface of the image display 130. Furthermore, the vibration unit 140 generates vibrations and applies them to the touch screen panel 110.

The vibration unit 140 comprises a piezoelectric (or polymer) actuator or motor which can be formed thin and generate vibration in such a way that it is expanded and contracted by external force in the longitudinal direction.

The shape of the vibration unit 140 is not limited to a special shape, but typically has a thin bar shape. The installation location of the vibration unit 140 is also not limited, but it is typically disposed on the perimeter of the lower surface of the image display 130.

As another embodiment, the vibration unit 140 may be disposed under the lower surface of the touch screen panel 110.

A second elastic member 141 is attached to the lower surface of the image display 130 on which the vibration unit 140 is mounted.

The second elastic member 141 prevents vibrations generated from the vibration unit 140 from being transmitted to lower elements including the support bracket 150, in other words, having a vibration insulation function.

The second elastic member 141 can be made not only of rubber or foam but also of any material which can ensure that the vibrations are insulated.

As such, because of the vibration insulation provided by the second elastic member 141, vibrations generated from the vibration unit 140 are transmitted only towards the touch screen panel 110 while it is prevented from being transmitted to the support bracket 150.

Furthermore, an adhesive material is applied to the upper and lower surfaces of the second elastic member 141 to fasten the image display 130 to the support bracket 150.

In addition, an opening is formed through the central portion of the second elastic member 141 to avoid contact with the vibration unit 140.

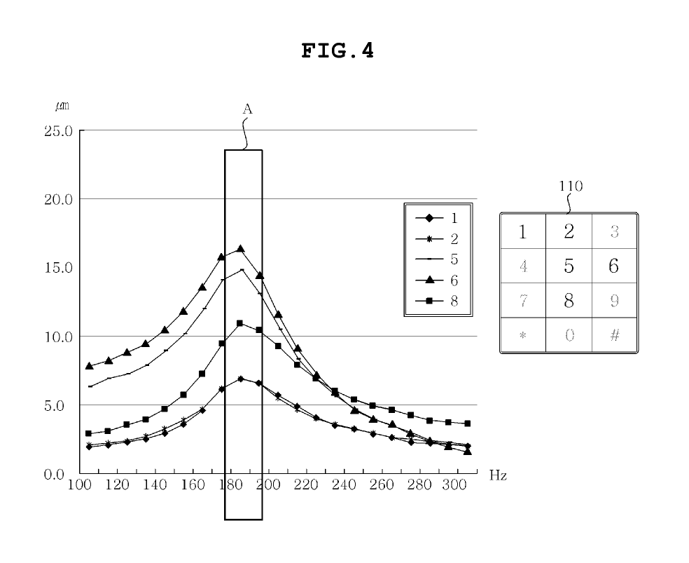

FIG. 4 illustrates the characteristics of the touch screen device 100 when the hardness of the first elastic member 111 is 20. In detail, FIG. 4 is a graph showing the displacement (variation distance) of the touch screen panel 110 as a function of a frequency of the vibration unit 140 when the hardness of the first elastic member 111 which is made of silicone rubber is 20.

The reference numerals 1, 2, 5, 6 and 8 of the graph denote the numerals expressed on the touch screen panel 110 to indicate locations on the upper surface thereof.

As shown in the graph of FIG. 4, regardless of the location on the upper surface of the touch screen panel 110, when the frequency of the vibration unit 140 ranges from 180 to 200 Hz, the displacement of the touch screen panel 110 is largest.

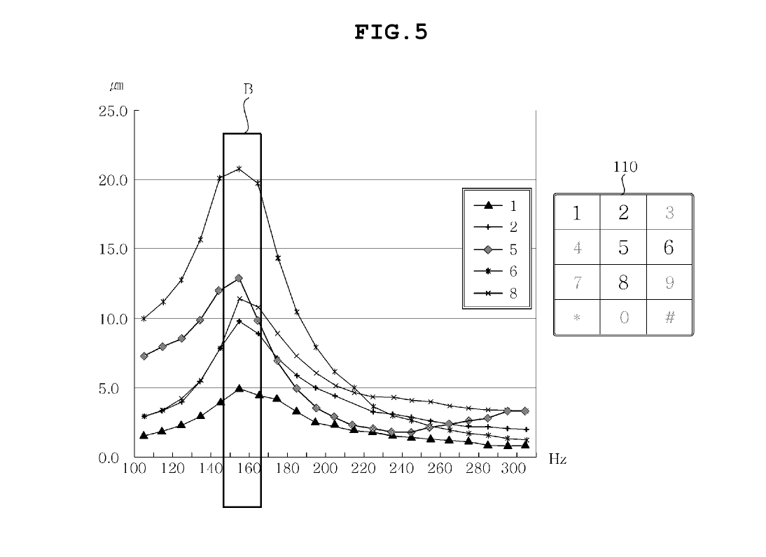

FIG. 5 illustrates the characteristics of the touch screen device 100 when the hardness of the first elastic member 111 is 50. In detail, FIG. 5 is a graph showing the displacement (variation rate) of the touch screen panel 110 as a function of a frequency of the vibration unit 140 when the hardness of the first elastic member 111 made of silicone rubber is 50.

The reference numerals 1, 2, 5, 6 and 8 of the graph denote the numerals expressed on the touch screen panel 110 to indicate locations on the upper surface thereof.

As shown in the graph of FIG. 5, regardless of the location on the upper surface of the touch screen panel 110, when the frequency of the vibration unit 140 ranges from 150 to 170 Hz, the displacement of the touch screen panel 110 is largest.

As can be appreciated in FIGS. 4 and 5, the displacement (variation rate) of the touch screen panel 110 depending on the frequency of the vibration unit 140 can be controlled by varying the hardness of the first elastic member 111.

Therefore, a sensation of touch on the tip of a finger of the user can be varied depending on the frequency of the vibration unit 140. The present invention can provide the vibration unit 140 which applies different frequencies depending on the requirements of the user who wants, for example, small or large vibrations.

In the touch screen device 100 according to the present invention having the above-mentioned construction, the first elastic member 111 is disposed between the touch screen panel 110 and the upper casing 120, and the second elastic member 141 is disposed between the image display 130 and the support bracket 150. Thus, the rate at which vibrations generated from the vibration unit 140 are transmitted to the touch screen panel 110 can be maximized, while vibrations transmitted from the vibration unit 140 to the lower elements are minimized.

As well, force of the vibrations transmitted to the user when touching the touch screen panel 110 can be varied by changing the hardness of the first elastic member 111. Hence, the present invention can meet the requirements of consumers who want various sensations of vibration.

As such, the touch screen device 100 of the present invention may be able to maximize a sensation of vibration applied to the user when touching the touch screen panel 110, or it may be able to provide various sensations of vibration to the user. Therefore, the marketability can be markedly enhanced.

Although the embodiment of the present invention has been disclosed for illustrative purposes, it will be appreciated that a touch screen device according to the invention is not limited thereby, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A touch screen device, comprising:
an upper casing;
a touch screen panel receiving a touch signal from a user;
a first elastic member provided under the touch screen panel;
an image display provided under the touch screen panel to display images;
a vibration unit mounted under the image display to generate vibrations;
a second elastic member provided under the image display to prevent the vibrations of the vibration unit from being transmitted downwards; and
a support bracket provided under the second elastic member to support the second elastic member.

2. The touch screen device as set forth in claim 1, wherein the first elastic member has a shape corresponding to a perimeter of the upper casing.

3. The touch screen device as set forth in claim 1, wherein vibrational force applied to the touch screen panel varies depending on a hardness of the first elastic member.

4. The touch screen device as set forth in claim 1, wherein an adhesive material is applied to each of upper and lower surfaces of the first elastic member, so that the touch screen panel is fastened to the upper casing by the first elastic member.

5. The touch screen device as set forth in claim 1, wherein the vibration unit comprises a piezoelectric or polymer actuator or motor.

6. The touch screen device as set forth in claim 1, wherein a displacement of the touch screen panel varies depending on a frequency of the vibration unit.

7. The touch screen device as set forth in claim 1, wherein an adhesive material is applied to each of upper and lower surfaces of the second elastic member, so that the image display is fastened to the support bracket by the second elastic member.
